(19) United States
(12) Patent Application Publication
(10) Pub. No.: US 2013/0279598 A1
(43) Pub. Date: Oct. 24, 2013

(54) Method and Apparatus For Video Compression of Stationary Scenes

(71) Applicant: Ryan G. Gomes, Santa Monica, CA (US)

(72) Inventor: Ryan G. Gomes, Santa Monica, CA (US)

(21) Appl. No.: 13/651,458

(22) Filed: Oct. 14, 2012

Related U.S. Application Data
(60) Provisional application No. 61/547,674, filed on Oct. 14, 2011.
(60) Provisional application No. 61/597,615, filed on Feb. 10, 2012.
(60) Provisional application No. 61/697,739, filed on Sep. 6, 2012.

(51) Int. Cl. H04N 7/26

(52) U.S. Cl. CPC H04N 19/00945
USPC 375/240.24; 375/240.27

(57) ABSTRACT

The present system provides a method and apparatus for video compression of stationary scenes. These scenes may be taken by a fixed or temporarily fixed camera, such as, for example, a security camera. In theory, a stationary scene has a static background upon which objects move. However, due to environmental conditions, such as sun position, lighting changes, wind and weather, clouds, fog, and the like, the background is not consistently static. The system provides a dynamic and adaptive Scene Model to allow the subtraction of the static portions of a scene under a plurality of conditions, providing the bandwidth and storage capacity to record moving objects with higher fidelity at lower storage cost than prior art systems. In an alternate embodiment, the system uses Perceptual Filtering as a preliminary step to coding, significantly reducing the amount of data to be compressed at high fidelity.

This patent application claims priority to U.S. Provisional Patent Application Ser. No. 61/547,674 filed Oct. 14, 2011, U.S. Provisional Patent Application Ser. No. 61/597,615 filed Feb. 12, 2012, and U.S. Provisional Patent Application Ser. No. 61/697,739 filed Sep. 6, 2012, all of which are incorporated by reference herein in their entirety.

### BACKGROUND

Compression is a scheme for reducing the amount of information required to represent data. Data compression schemes are used, for example, to reduce the size of a data file so that it can be stored in a smaller memory space. Data compression may also be used to compress data prior to its transmission from one site to another, reducing, the amount of time required to transmit the data. To access the compressed data, it is first decompressed into its original form. A compressor/decompressor (codec) is typically used to perform the compression and decompression of data.

One application of data compression is in the field of security systems. Many homes and businesses incorporate cameras as part of a security system or employee monitoring system. Regardless of the intended use, many of these cameras are stationary and point at the same location at all times.

A disadvantage of current systems is that the storage of data is a significant cost when collecting video data 24 hours a day, 7 days a week. To reduce storage requirements, the prior art has used a number of techniques. One technique is to not have the camera on at all times, but instead to record images at repeated intervals (e.g. 1 second two second, and the like). A disadvantage of this approach is that any resulting video will be choppy and may not reveal important actions or detail that may be required upon review of the video data.

Another approach is to compress the data from the camera to reduce the size of the video stream and thereby reduce storage requirements. These approaches typically are “lossy” compression techniques. In lossy compression, data and video information is discarded during the compression process. A disadvantage of this approach is that decompression of the compressed data is not the full recorded data, again resulting in missing information that may be critical. Often the details of uncompressed security video is so lacking that it may be difficult to identify a face of a person in the view of the camera, defeating the purpose of a security system.

one prior an video compression approach is referred to as “wavelet” compression. In the compression pipeline, the image is divided into blocks and the average color of each block is computed. The system computes an average luminance for each block and differential luminances of each pixel of the plurality of pixels of each block. The system computes an average color difference between each block and the preceding block, and quantizes the average color difference and the first plurality of frequency details using Lloyd-Max quantization. The quantized average color difference and a second plurality of frequency details are encoded using variable length codes. The system employs lookup tables to decompress the compressed image and to format output pixels. A disadvantage of wavelet compression for security applications is that the entire data of each frame is analyzed, and the compression ratio is still too high to allow for economic storage of high quality video data.

Another approach is to only enable the recording of images when motion is detected in the image field of the camera. This reduces the amount of data to be stored to only data that is relevant, namely when movement is detected. However, disadvantages of such a system includes unwanted triggering from small animals, wind movement, legitimate personnel in frame, and the like. In addition, the system may turn itself off if an intruder or other moving body remains still for certain periods of time. In addition, it sometimes is important to have images available from before and after detected movement, which is not possible with this technique.

Another approach is a technique, used in mpeg encoding, to only store differences between successive frames of video. The theory is that the majority of a video frame is substantially identical to the immediately preceding frame. The first frame is used in its entirety. Subsequent frames are analyzed to detect the differences between the preceding frame and the next frame. Only the data regarding the differences is kept, substantially reducing the data load and storage requirements. Periodically, the system must reset by storing another full frame, to reduce the propagation of errors and to improve quality. A disadvantage of this approach is that the compression ratio is still not sufficient to allow high quality recording, and playback without an unwanted storage cost.

### SUMMARY

The present system provides a method and apparatus for video compression of stationary scenes. These scenes may be taken by a fixed or temporarily fixed camera, such as, for example, a security camera. In theory, a stationary scene has a static background upon which objects move. However, due to environmental conditions, such as sun position, lighting changes, wind and weather, clouds, fog, and the like, the background is not consistently static. The system provides a dynamic and adaptive Scene Model to allow the subtraction of the static portions of a scene under a plurality of conditions, providing the bandwidth and storage capacity to record moving objects with higher fidelity at lower storage cost than prior art systems. In an alternate embodiment, the system uses Perceptual Filtering as a preliminary step to coding, significantly reducing the amount of data to be compressed at high fidelity.

These and further embodiments will be apparent from the detailed description and examples that follow.

### BRIEF DESCRIPTION OF THE DRAWINGS

The present system is herein described, by way of example only, with reference to the accompanying drawings, wherein:

FIG. 1 illustrates an example of a prior art video encoder.

FIG. 2 represents the function of an embodiment of the system.

FIG. 3 is a flow diagram illustrating macroblock classification in an embodiment of the system.

FIG. 4 is a flow diagram illustrating region processing in an embodiment of the system.

FIG. 5 illustrates an embodiment of the Scene Model of the system.

FIG. 6 illustrates an embodiment of the perceptual the filter of the system.

FIG. 7 is a flow diagram illustrating, the operation of an embodiment of the system.

FIG. 8 illustrates an embodiment of the perceptual filter of the system.

FIG. 9 illustrates an embodiment of the change detection of the system.

FIG. 10 is an example computer embodiment of the system.

### DETAILED DESCRIPTION

The present system exploits the regularities associated with stationary scene video to achieve greater compression than afforded by existing video coding methods. The system utilizes a number of approaches that can be used separately or together to reduce data storage requirements by ignoring static portions of an image and using high fidelity processing only on those portions of an image with objects of interest. The system operates in one or more of a Scene Model mode or a Perceptual Filtering Mode.

Scene Model

A continuously adapting Scene Model represents the typical variability associated with the background. Using this model, significant visual changes are detected as anomalies that are detectably different from the background. Examples include: non-background objects, reflections, or umbral shadows. These visual phenomena are encoded with high visual quality since they are typically regarded as the most important by viewers (particularly in surveillance applications). Visual changes due to camera noise, repetitive non-coherent motion (e.g., swaying leaves) and subtle lighting changes are classified as background events. Camera noise is suppressed and is not encoded. Lighting changes and repetitive motion are encoded using low visual quality which may be accomplished at a lower data rate.

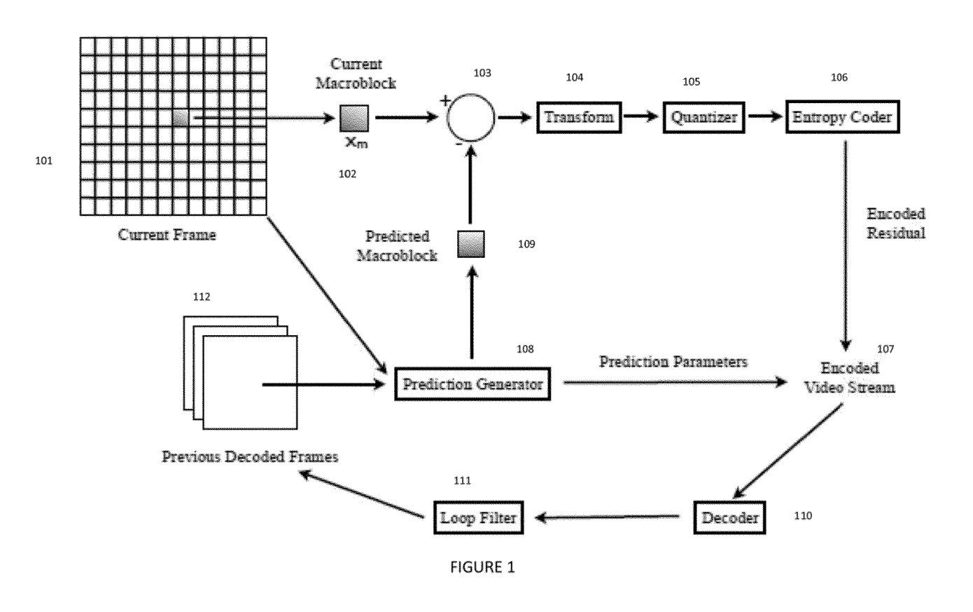

FIG. 1 is an example of an mpeg type video coder used in the prior art. FIG. 1 depicts the typical architecture of a hybrid video coder. Image frames such as Current Frame 101 are segmented into rectangular regions known as macroblocks, which are encoded in a sequential manner. The mth macroblock 102 as Xₘ which is a D-dimensional vector of pixel luma and chroma values contained within the region of the macroblock 102. The coder computes the residual difference between the current image macroblock 102 Xₘ and a predicted macroblock 109. Current hybrid coders allow for frames that use Intra prediction (I-frames) in which macroblocks from the current frame are used to derive the predicted macroblock. Inter-prediction (P and B frames) makes use of previously decoded frames. This residual output from difference 103 is then transformed at transform 104 into an alternate basis (often the Discrete Cosine or closely related transform). The resulting basis coefficients are then quantized at quantizer 105 in order to reduce the amount of data required to encode them. This is a fundamentally lossy process and leads to a tradeoff between image quality and output bit rate. The quantized transformed residual is then losslessly compressed using an entropy coder 106 to create Encoded Video Stream 107. The hybrid video coder maintains an integrated decoder 110 and loop filter 111, which reconstruct the frames as they appear to the decoder. These decoded frames may then be stored in memory and used to form the basis of subsequent predictions and are provided, along with the current frame, to Prediction Generator 108 to produce predicted macroblock 109. The Prediction Generator 108 also produces Prediction Parameters that are used along, with the Encoded Video Stream 107 in the Decoder 110.

Scene Model

This invention consists of a Scene Model that is used to control the operation of a hybrid video coder. The Scene Model represents the visual appearance for each macroblock. In operation, the system determines whether a macroblock is a Background block or an Anomaly Block. A Background Block is considered static and can be treated in a lower fidelity manner with lower storage requirements. An Anomaly Block is considered to represent an area of interest (such as movement of a person) and is treated in a high fidelity manner so that high quality replay may be possible while substantially limiting storage requirements.

FIG. 3 is to flow diagram illustrating, the operation of an embodiment of the system in operating on a current macroblock. At step 301, the system investigates a macroblock from a current image frame. At decision step 302 the system determines if the macroblock was previously classified as a Background Block. If so, the system proceeds to the path beginning with step 303. If not, the macroblock is an Anomaly Block and is processed in path beginning with step 307.

At step 303 the normalized reconstruction error of the macroblock is determined. At decision step 304 it is determined if the reconstruction error is less than a pre-defined threshold. This indicates whether the macroblock evidences so much change that it likely represents an anomaly, or whether it has changed so little that it represents a static background. If the reconstruction error is below the threshold the system proceeds to step 305 and the classification of the macroblock as a Background Block is maintained. If the reconstruction error is above the threshold, then the classification of the macroblock is changed to that of an Anomaly Block at step 306.

If the macroblock at step 302 is not a Background Block then it is an Anomaly Block and is processed at step 307 where the reconstruction error of the macroblock compared to the prior macroblock at that location is determined. At decision step 308 it is determined if the reconstruction error is below a predefined threshold. If so, the macroblock is reclassified as a Background Block at step 310. If it is above the threshold at step 308, then it remains classified as an Anomaly Block at step 309.

In one embodiment, the threshold levels may be adaptive and dynamic based on additional statistics of the reconstruction error, such as its variance or statistical quantities.

To enable characterizations of the macroblocks, a collection of numerical quantities are maintained for each macroblock. The value mm is the mean vector associated with the mth macroblock. Urn is a D×K orthogonal matrix that represents a K-dimensional subspace that encompasses the variation of macroblock in due to small lighting changes and repetitive motion (e.g., running water or swaying leaves). The number of basis vectors K<<D is chosen as a fixed parameter. The scene model computes for each macroblock:

yₘ=xₘ−mₘ

rₘUₘ^{T}yₘ

cₘyₘ^{T}yₘ−rₘ^{T}r_{m.}

yₘ is the vector difference between the current macroblock xₘ and the mean location mₘ. rₘ is the projection of this vector difference on to the subspace Uₘ. eₘ is the reconstruction error: it captures the extent to which the current macroblock is well represented by the scene model, with smaller reconstruction errors indicating better accordance with the model. The average reconstruction error is tracked with Um.

The scene model then locally classifies the current macroblock's appearance as either background (consistent with typical background variation or lighting change) or as an anomaly. Background is indicated by bₘ=1 and anomaly by bₘ=0. Local classification is done according to a hysteresis threshold rule:

$${b}_{m} = \{ \begin{matrix}I [ \frac{{e}_{m}}{{σ}_{m}} < {λ}_{1} ] & if {b}_{m} = 1 \\ I [ \frac{{e}_{m}}{{σ}_{m}} < {λ}_{0} ] & if {b}_{m} = 0\end{matrix}$$

The system also allows the definition of regions of macroblocks as Background Blocks or Anomaly Blocks improving, the robustness of the system. There can be situations where a region is undergoing an Anomalous change but it is incorrectly classified by the system as Background. For example, if a person wearing a white shirt walks in front of a white wall, the difference in appearance between the shirt and the wall may be very subtle, and therefore incorrectly classified by the system, yet noticeable to the human eye. However, neighboring regions of the person will be very distinct (e.g., the head, the edges of the shirt, etc.) and correctly classified as anomalous. Therefore, the system assumes if a region is surrounded by anomalous regions, it is also anomalous. The region analysis helps to enable this.

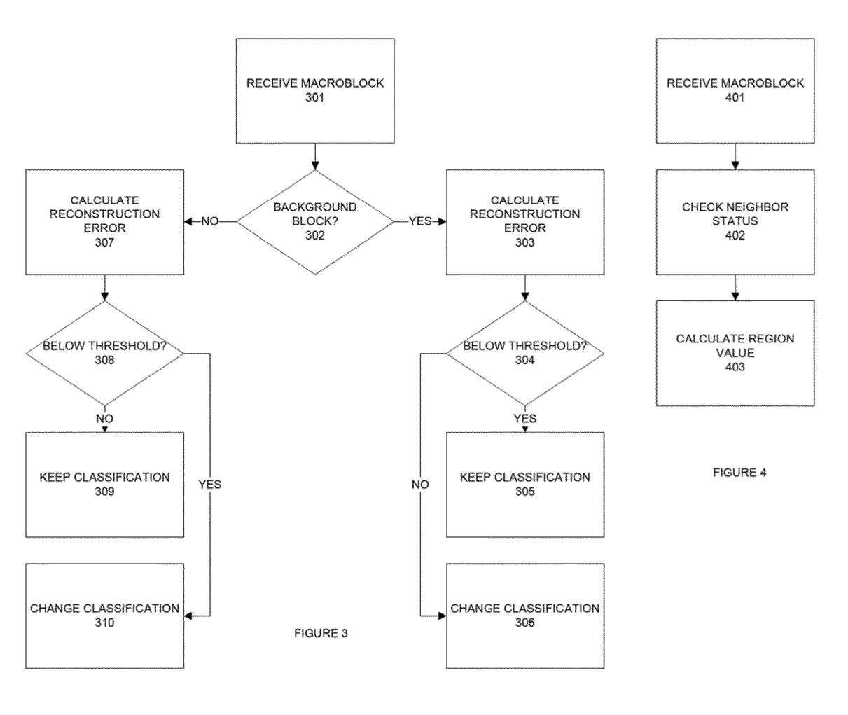

Referring to FIG. 4, the system receives a macroblock for review at step 401. At step 402 the system checks the status of the immediate neighbors of the macroblock. This may consist of the eight closest neighbors (i.e. those that touch the macroblock, or some other number of nearby neighbors. At step 403 the system computes a region based classification bₘ. In one embodiment, this may be accomplished by:

\hat{b}ₘ= [symbol] ₘ{b}

The region operator may be, for example,

$${\hat{b}}_{m} = \{ \begin{matrix}0 & if T of macroblock m ' s neighbors have b = 0 \\ {b}_{m} & Otherwise .\end{matrix}$$

Alternatively. Rₘ{b} may consist of image morphological operations or a probabilistic model such as a Markov Random Field which takes neighboring local classifications (b's) and reconstruction errors (e's) as evidence. Optionally, motion vectors associated with neighboring macroblocks (which are computed in the motion compensation unit of a standard hybrid video coder) may be incorporated into the region based classification. If neighboring motion vectors exceed a threshold, they may force a macroblock to be classified as anomaly, depending on user preference.

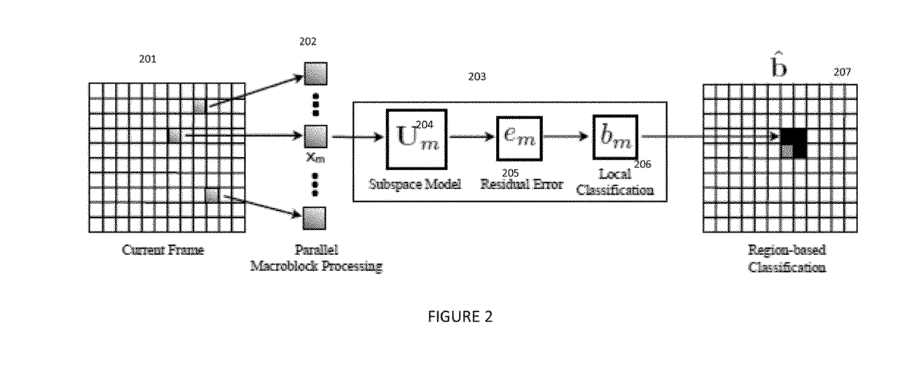

FIG. 2 represents the function of an embodiment of the system. A current frame 401 is divided into a plurality of macroblocks 202 that may be processed in parallel. The processing block 203 includes a subspace model 204 to generate Uₘ along with residual error 205 and local classification 206. The result is a frame 207 where macroblocks are identified and may be classified on a region basis.

Scene Model Learning

One of the goals of the system is to be able to more accurately identify those macroblocks that truly represent Anomaly Blocks from those that don't. For example, there may be fleeting phenomena in a macroblock that could trigger a re-classification of a Background Block to an Anomaly Block, but that don't truly represent objects of interest. The fewer misclassified blocks that are stored in high fidelity, the better the compression ratio that can be achieved.

The system specifies a novel robust subspace tracking algorithm that prevents anomalies (such as a moving object that passes through a macroblock region) from unduly influencing the subspace Uₘ estimate. However, if an object lingers in a macroblock region for an extended period of time, the robust subspace tracking method adapts the subspace to this new representation and allows reclassification. The scene model updates the subspace Uₘ using the following equations:

$${δ}_{m} = sign ( {y}_{m} - {U}_{m}^{T} {r}_{m} )$$

$${T}_{m} = {U}_{m} + \frac{{μ}_{1}}{{y}_{m}^{T} {y}_{m}} ( {y}_{m} {δ}_{m}^{T} {U}_{m} + {δ}_{m} {r}_{m}^{T} )$$

$${a}_{m} = {r}_{m} - [ \begin{matrix}‖ {r}_{m} ‖ \\ 0 \\ ⋮ \\ 0\end{matrix} ]$$

$${Z}_{m} = {T}_{m} - \frac{2}{{a}_{m}^{T} {a}_{m}} {T}_{m} {a}_{m} {{a}_{m}^{T} \\ [ {U}_{m} ]}_{ik} = {\frac{1}{{\sum }_{i}^{ } {[ {Z}_{m} ]}_{ik}} [ {Z}_{m} ]}_{ik}$$

μ1 is a fixed learning rate parameter, which is typically set to 1.0. The mean vector mₘ and average reconstruction error σₘ are also updated in a robust fashion according, to the following rules

$${m}_{m} = {m}_{m} + {μ}_{0} I [ \frac{{e}_{m}}{{σ}_{m}} < {λ}_{1} ] ( {x}_{m} - {m}_{m} )$$

$${σ}_{m} = {σ}_{m} + {μ}_{0} I [ \frac{{e}_{m}}{{σ}_{m}} < {λ}_{1} ] ( {e}_{m} - {σ}_{m} )$$

μ0 is a fixed learning rate parameter. These statistics are updated when the normalized reconstruction error is less than the upper threshold λ1.

Encode Control

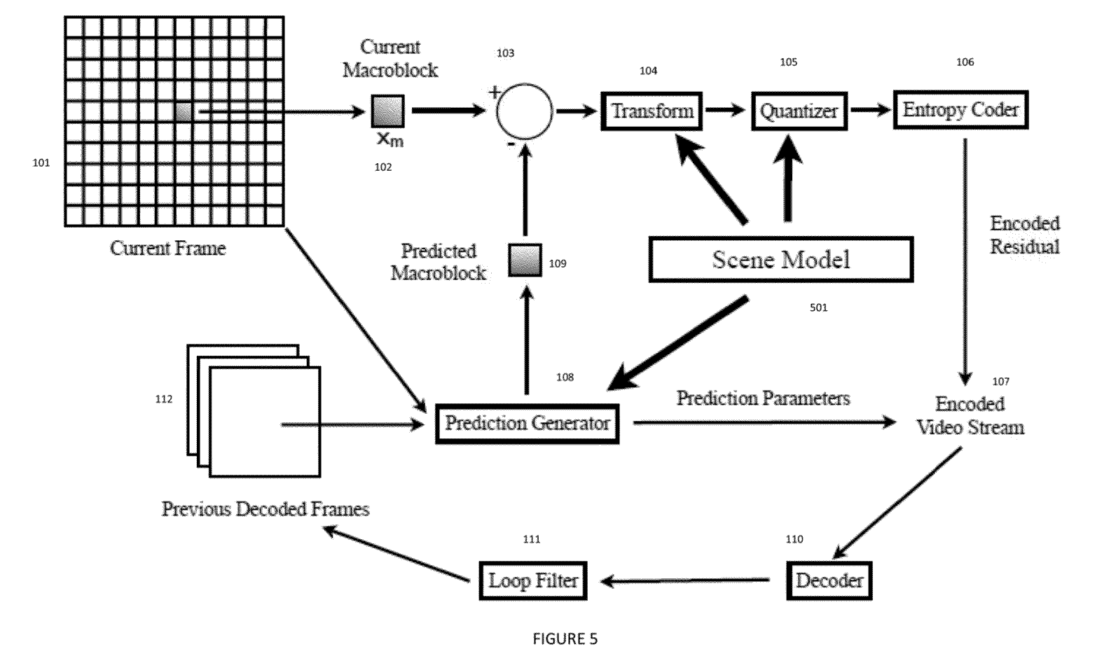

The system uses the Scene Model information described above to modify the operation of a video coder appropriately. The system in one embodiment modifies the operations of the Transform 104, Quantizer 105, and Prediction Generator 108. FIG. 5 is an example of one embodiment of the system incorporating the Scene Model approach. The structure is similar to FIG. 1 but has the additional functional block of the Scene Model 501. The Scene Model provides input to the Transform 104, Quantizer 105, and Prediction Generator 108 to modify their behavior depending on if the macroblock is a Background Block or an Anomaly Block.

Transform Operation

A prior art Transform component applies a Discrete Cosine (or closely related) transform T{•} to the residual block (the difference between the current macroblock xₘ and the predicted macroblock). The Scene Model of the system modifies this transform for each macroblock based on the background classification bₘ (i.e. whether the macroblock is a Background Block or an Anomaly Block). The alternative transform A{•} is given by

$$A \{ \cdot \} = \{ \begin{matrix}𝒯 \{ \cdot \} & if {\hat{b}}_{m} = 0 \\ 𝒯 \{ \cdot \} of & if {\hat{b}}_{m} = 1\end{matrix}$$

f is a fixed vector of integer numerical values (one for each of the transform outputs) and indicates elementwise multiplication. This amounts to filtering in the transform domain when the macroblock is classified as background. f is designed to retain low frequency lighting changes (which are perceptually relevant) while removing high frequency noise (which is perceptually irrelevant). Filtering in the transform domain leads to less data. Multiplying by f will reduce the size of some of the transform components, causing them to be removed by the Quantizer (105), and therefore not represented in the encoded bitstream.

Quantizer Operation

The Quantizer component's operation is defined by a Quantization Parameter (QP), where larger values indicate greater quantization, lower reconstruction fidelity, and greater data compression. For Background Blocks, the Quantizer Parameter will be a larger value. The Scene Model adjusts QPₘ for each macroblock. QPₘ may be set to a high value QP₁ when bₘ=1 and a lower value QP₀ when bₘ=0. This allows anomalies, such as newly introduced objects, to be captured with high fidelity, while background changes are captured with lesser fidelity. Alternatively, QPₘ may be adjusted dynamically and continuously as a fixed decreasing function of the normalized reconstruction error. The range of this function has an upper bound of QP₁ and a lower bound of QP₀, and allows for a smooth transition of image quality with the normalized reconstruction error.

Prediction Generator Operation

The video coder's Prediction Generator component 108 selects a predicted macroblock from a discrete set of possibilities, where the index j E {1, . . . , P} indicates the prediction choice and P is the total number of possible predictions. Prediction selection may be accomplished by Rate Distortion Optimization (RDO) according to

$$J = {argmin}_{j} ℱ = 𝒟 ( {x}_{m} , {\hat{x}}_{j} ) + v {ℛ}_{j} .$$

The prediction is chosen to minimize a cost function composed of V(xₘ, ̂xj), which captures the distortion between the macroblock x, and the decoded macroblock ̂xⱼ that results from choosing prediction mode j, and the rate Rⱼ which is the number of bits required to encode the block associated with mode j. v is a fixed Lagrange Multiplier that balances the tradeoff between rate and distortion.

The Scene Model influences its tradeoff by selecting v as a pre-specified function of the normalized reconstruction error:

$$J = {argmin}_{j} ℱ = 𝒟 ( {x}_{m} , {\hat{x}}_{j} ) + v ( \frac{{𝓁}_{m}}{{σ}_{m}} ) {ℛ}_{j}$$

Alternatively, the Scene Model may influence the distortion itself, casting it as a function of the reconstruction error and average reconstruction error in addition to the current macroblock and decoded macroblock as follows:

$$J = {argmin}_{j} ℱ = 𝒟 ( {x}_{m} , {\hat{x}}_{j} ; {𝓁}_{m} , {σ}_{m} ) + v {ℛ}_{j}$$

The system may also implement skip mode and Interframe prediction for Background Blocks and as appropriate in one embodiment.

Although the system is described in terms of stationary scenes, it is not limited to stationary cameras, lithe camera viewpoint changes, the system will adapt over time to the new viewpoint, defining Background Blocks and Anomaly Blocks as appropriate in the new viewpoint. In one embodiment, the system can detect a scene change via information from the camera motor, or when a some percentage of the macroblocks change between frames. In this situation, the system may re-initialize the Scene Model to reduce the amount of time it would take for the Scene Model to adjust to the new viewpoint. This prevents the unnecessary high fidelity encoding of background data.

Perceptual Filtering

Another technique implemented in an embodiment of the system is referred to as Perceptual Filtering. In this approach, a video sequence is processed to output a new video sequence that may be compressed with a high compression ratio using any of a number of compression techniques, including the Scene Model technique described herein.

In one embodiment, the system implements compression techniques that employ intra-frames and inter-frames, along with skip block operations. Current schemes can take advantage of two types of redundancy associated with a visual image, spatial redundancy and temporal redundancy. Spatial redundancy is the redundancy of data within an image frame and is thus related to intra-frames. Temporal redundancy relates to the redundancy of data between frames (over time) and is thus related to inter-frames.

Intra-frames are compressed by removing spatial redundancy exclusively, independent of prior or succeeding frames. Thus, intra-frames can be decoded without reference to any other frame in the sequence. By contrast, inter-frames are compressed and decoded with reference to other frames in the sequence. An additional prior art compression technique is referred to as skip coding. If a macroblock in a frame has not changed significantly (i.e. more than a threshold amount) relative to the corresponding block in a reference frame, then that macroblock is not processed and the corresponding macroblock from the reference frame is used in its place.

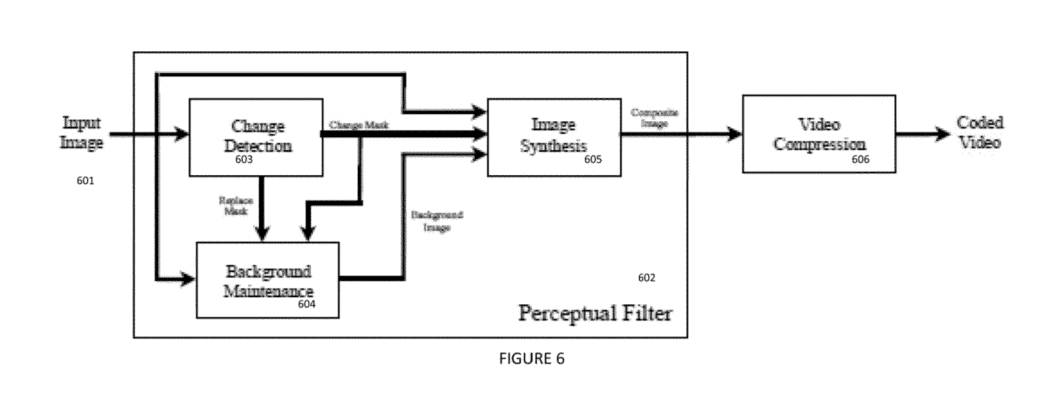

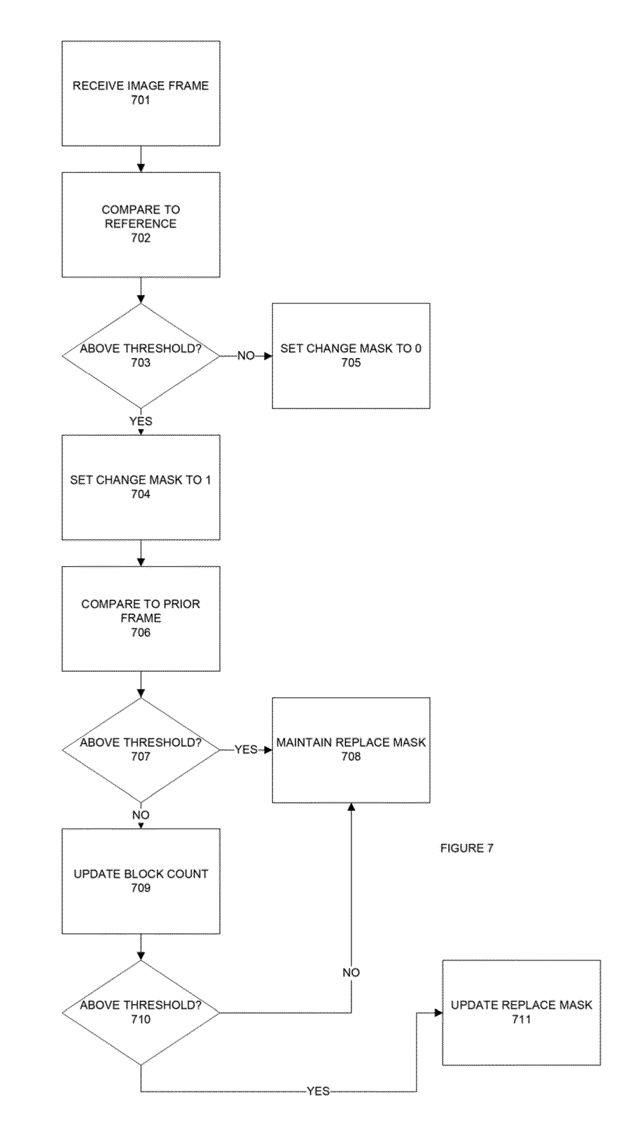

FIG. 6 illustrates an example of the Perceptual Filter of an embodiment of the system. The Perceptual Filter 602 processes the input video sequence 601, and outputs a modified video sequence which is then compressed at Video Compression block 606. The Perceptual Filter 602 includes Background Maintenance unit 604, Change Detection unit 603, and Image Synthesis unit 605.

The Background Maintenance unit 604 maintains an image that represents the slowly changing elements of a stationary scene. A Change Detection unit 603 determines image regions in the current image frame that have changed in a perceptually relevant fashion relative to the background image. An Image Synthesis unit 605 composes a Composite image frame in which regions of the image that have significantly changed are retained, and image regions that have changed in a perceptually insignificant way are replaced with the corresponding region in the Background Image. The Composite Image is then passed to the Video Compression unit for encoding. The Perceptual Filter 602 takes as input an image I which has pixel values Iₚ and out-puts the image O with pixel values Oₚ. Pixel values may be scalar intensity values or multi-dimensional color values.

Change Detection

The Change Detection unit 603 determines regions in the input image that are undergoing perceptually relevant change relative to the stationary background scene. It is designed to highlight only perceptually relevant changes and ignore nuisance changes. A number of approaches to this problem exist in the literature and are known to those skilled in the art.

The unit outputs a Change Mask c with elements cₘ that is equal to 1 if there is a relevant change in the mth image region, and equal to 0 otherwise. The image regions indexed by m may be individual pixels, or they may be larger regions. For example, in one embodiment, the regions are defined to be identical to the macroblocks used by the Video Compression system 606.

The unit also outputs a binary Replace Mask s with elements sₘ that is equal to 1 if the mth region in the stationary background scene has undergone a significant change, and equal to 0 otherwise. This may happen if an object enters the scene and becomes stationary (e.g., a car enters the image view and is parked. Initially the moving car will be an object of interest, but after it is parked, there is no need to store high fidelity data of the car for each frame). The system will replace the reference region for a macroblock or region if the changed block has been stable for a certain number of frames. Thus, the system compares each block with a reference frame and, for blocks that have changed, with a prior frame.

FIG. 7 is a flow diagram illustrating the operation of the Change Detection unit 603 in an embodiment of the system. At step 701 the unit receives an image frame from the camera. The system then performs the following operations for each macroblock of the image frame. At step 702 the system compares the macroblock with a reference macroblock in the same corresponding location. At decision block 703 it is determined if there is a change between macroblocks above a predefined threshold. If not, the system sets the change mask to 0 at step 705. If so, the system sets the change mask to 1 at step 704.

The system also operates to determine if the reference frame should be updated to incorporate a new stationary feature (e.g. parked car, shadow from cloud or moving sun, environmental condition, and the like). The reference frame represents data that is static for some meaningful period of time, which can be on the order of seconds, minutes, or hours. To accomplish this, if a block has changed at step 704, the system compares that block to the corresponding block in the prior frame at step 706. The system then checks to see if the change is above a certain threshold at decision block 707. If there is a change above a certain threshold, it is assumed that there is a moving object of interest in that block and the replace mask is maintained at step 708. If there is no threshold change detected at step 707, the system increments a block count for that macroblock at step 709. Each count represents a number of frames where the block has not changed. The system checks to see if a certain count (i.e. number of frames) has been reached at decision block 710. If there is more than a threshold amount, the system assumes that this change object has become stationary and it can be incorporated into the background reference frame, improving compression performance in subsequent frames and it updates the replace mask at step 711. If not, the system maintains the replace mask at step 708.

The Change Detection unit outputs the Change Mask, Replace Mask, and input image to the Background Maintenance unit 604.

Background Maintenance

The Background Maintenance module takes the Input Image, the Change Mask, and the Replace Mask as inputs, and outputs the current Background Image B which has pixels Bₚ. In this embodiment. Rₚ denote the image region that contains the pixel indexed by p. Each pixel is updated according to:

$${B}_{p} = \{ \begin{matrix}( 1 - λ ) {B}_{p} + λ {I}_{p} & if {c}_{{R}_{p}} = 0 \\ {I}_{p} & if {s}_{{R}_{p}} = 1 \\ {B}_{p} & Otherwise .\end{matrix}$$

If the pixel's corresponding image region was marked by the Change Detection unit as unchanged, then the pixel is updated according to an online mean update with learning rate λ<1. (It is also possible to use an online estimator of the pixel median, rather than the mean.) When λ is small, the Background Image changes slowly over time, allowing it to track slow changes (such as illumination change with the time of day) while remaining largely invariant to fast perceptually irrelevant changes such as camera noise. If the Change Detection unit marks the region as undergoing a significant change to the background (its Replace Mask value is equal to 1), the Background Image region is updated with the current Image Region. If the image region is undergoing a perceptually relevant change, such as a moving object, the Background image region is left unchanged.

The online mean update rule effectively removes noise from the Background Image, improving its visual quality relative to the input video. However, in some cases this filtering may be undesirable, such as in the case of nuisance motion in the background which may lead to blurring. As an alternative, the Background Image may be periodically updated every T frames. The update rule is then:

$${B}_{p} = \{ \begin{matrix}{I}_{p} & if {s}_{{O}_{p}} = 1 or mod ( F , T ) = 0 and {c}_{{R}_{p}} = 0 \\ {B}_{p} & Otherwise .\end{matrix}$$

where F maintains a count of the number of Input Image frames processed by the Perceptual Filter. Ideally T is chosen so that periodic changes in the Background Image coincide with the Infra coded frames output by the Video Compression system.

Image Synthesis

The image Synthesis unit receives the Input Image, the Change Mask, and the Background Image as inputs. It outputs a composite image O with pixel values Oₚ. In its most basic form, the Output Image is composed as:

$${O}_{p} = \{ \begin{matrix}{I}_{p} & if {c}_{{R}_{p}} = 1 \\ {B}_{p} & Otherwise .\end{matrix}$$

for all pixel indices p. The Output Image consists of image regions from the input Image where significant changes are detected, and image regions from the Background Image where there is no significant change.

In some cases, visible contrast edges may appear along boundaries of regions where the change mask is 1 with those where the change mask is 0. In one embodiment, this can be reduced by applying deblocking filtering along regions where there is a difference in change mask values (if all the neighbors have the same change mask number, there is no need for the filtering, only where neighbors have different change mask numbers).

Multi-Level Change Mask

In one embodiment, the system may implement a Change Detection unit that outputs a tri-level change mask that differentiates between object changes, illumination changes, and background changes. In this embodiment, the Image Synthesis module may be configured to include Input Image regions undergoing illumination change in the Composite Image or to replace them with the corresponding, Background Region, depending on the application.

It may also be advantageous to augment the Change Detection module with object recognition classifiers (known to those skilled in the art) in this case, the Change Mask may take an arbitrary number of values. One value may correspond to perceptually irrelevant background change, while the rest are assigned to categories of objects. The Image Synthesis module may then handle each object category differently. For example, object categories determined to be of special relevance to the application may be rendered with higher visual quality (therefore requiring more data to represent them) than unimportant object categories.

Transform Filtering

Standard Video Compression systems typically apply a reversible transform (such as the Discrete Cosine Transform) to a prediction residual associated, with each macroblock. The resulting transform coefficients are then quantized and only significant coefficients are used to encode the macroblock. The tradeoff between reproduction quality and coding size may be controlled by varying the quantization level.

The Perceptual Filter may control the trade-off between reproduction quality and coding size selectively for different image regions, depending on the value of the Change Mask. The Image Synthesis module applies the coding transform (identical to that used by the Video Compression system) to each macroblock, and then quantizes the result using a quantization level associated with the mask value of the image region. Then, the reverse transform is applied to the quantized coefficients to generate the Composite Image macroblock. This effectively limits the number of significant transform coefficient values used available to the Video Compression system on a region by region basis.

Modified Background Maintenance

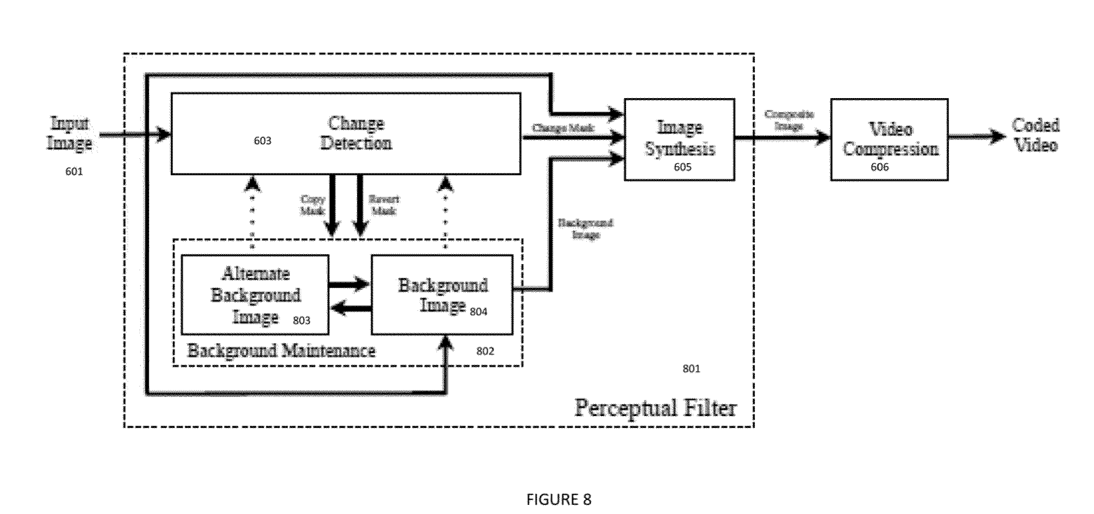

In another embodiment, the system identities foreground objects (i.e. those that are perceptually relevant) and background objects (i.e. those that are perceptually irrelevant). FIG. 8 is an example of this embodiment and represents another embodiment of the system of FIG. 6. The Perceptual Filter 801 includes a modified Background Maintenance unit 802 that is comprised of Alternate Background image unit 803 and Background image unit 804. The Input Image 601 is provided to the Change Detection unit 603 and to Image Synthesis Block 605 and Background Image unit 804.

In operation, Input image frames 601 arrive in a sequence. Upon arrival of a new image, the Change Detection module partitions the image into perceptually relevant foreground changes and irrelevant background changes, as indicated by the Change Mask. The Background Maintenance module 802 continuously updates a Background Image 804 based on the Input Image. Portions of the Background Image 804 may be copied to the Alternate Background Image 803 during periods when an image region is undergoing a foreground change. The Change Detection module 603 may make use of the Background 804 and Alternate Background Images 803, or it may rely solely upon its own internally maintained statistics. The Background image 804 may revert back to the alternate stored background region when the foreground change ends. The Image Synthesis unit 605 creates a new Composite Image composed of regions of the input image (where the change is deemed perceptually relevant) as well as regions of the background image (where any changes are perceptually irrelevant.) Finally, the composite image is passed to the Video Compression module 606, which outputs encoded video.

Change Detection

The Change Detection unit 603 determines regions in the input image that are undergoing perceptually relevant change, relative to the stationary background scene. It is designed to highlight only perceptually relevant changes and ignore nuisance changes and may use any of well know techniques for identifying differences.

The unit 603 outputs a Change Mask c with elements cₚ that are in the range of [Cₘᵢₙ, Cₘₐₓ]. Typically, C=0.0 and Cₘₐₓ=1.0 if floating point encoding is used, or Cₘᵢₙ=0 and Cₘₐₓ=255 if 8-bit integer encoding is used. The mask value cₚ is equal to Cₘₐₓ if there is a relevant change in the mth image region, and equal to Cₘᵢₙ otherwise. Intermediate values between 0 and 1 may be used to enable a smooth transition between foreground and background, which may reduce image artifacts during the image composition stage.

The unit also outputs a binary Copy Mask s with pixel elements sₚ that are equal to 1 when the pth pixel makes a transition from background to foreground. The binary Revert Mask r with elements rₚ take the value 1 when pixel p that was undergoing a foreground change returns to the background pixel stored in the Alternate Background Store 803.

Background Maintenance

The Background Maintenance module takes the input image, the Copy Mask, and the Revert Mask as inputs, and outputs the current Background Image B which has pixels BR. Each pixel is updated according to:

Bₚ=(1−λ)Bₚ+λIₚ

Each background pixel is updated according to an online mean update with learning rate λ<1. (It is also possible to use an online estimator of the pixel median, rather than the mean). When λ is small, the Background image 804 changes slowly over time, allowing it to track slow changes (such as illumination change with the time of day while remaining largely invariant to fast perceptually irrelevant changes such as camera noise.

An Alternate Background Image A with pixels Aₚ is used to retain portions of the background image that are currently undergoing a foreground change. The update rule is:

$${A}_{p} = \{ \begin{matrix}{B}_{p} & if {s}_{p} = 1 \\ {A}_{p} & Otherwise .\end{matrix}$$

The values stored in the Alternate Background Store 803 may be returned, to the Background Image 804 according to the revert mask r:

$${B}_{p} = \{ \begin{matrix}{A}_{p} & if {r}_{p} = 1 \\ {B}_{p} & Otherwise .\end{matrix}$$

Image Synthesis

The image Synthesis unit 605 receives the Input image, the Change Mask, and the Background Image as inputs. It outputs a composite image O with pixel values Oₚ. The composite image is formed via Alpha Blending of the input image I and the Background Image B, according to the Change Mask c:

Oₚ=cₚ×Iₚ+(1−cₚ)×bₚ

When integer encoding is used for the change mask, the above multiplications may involve a scaling step to retain the proper integer value range.

Modified Change Detection

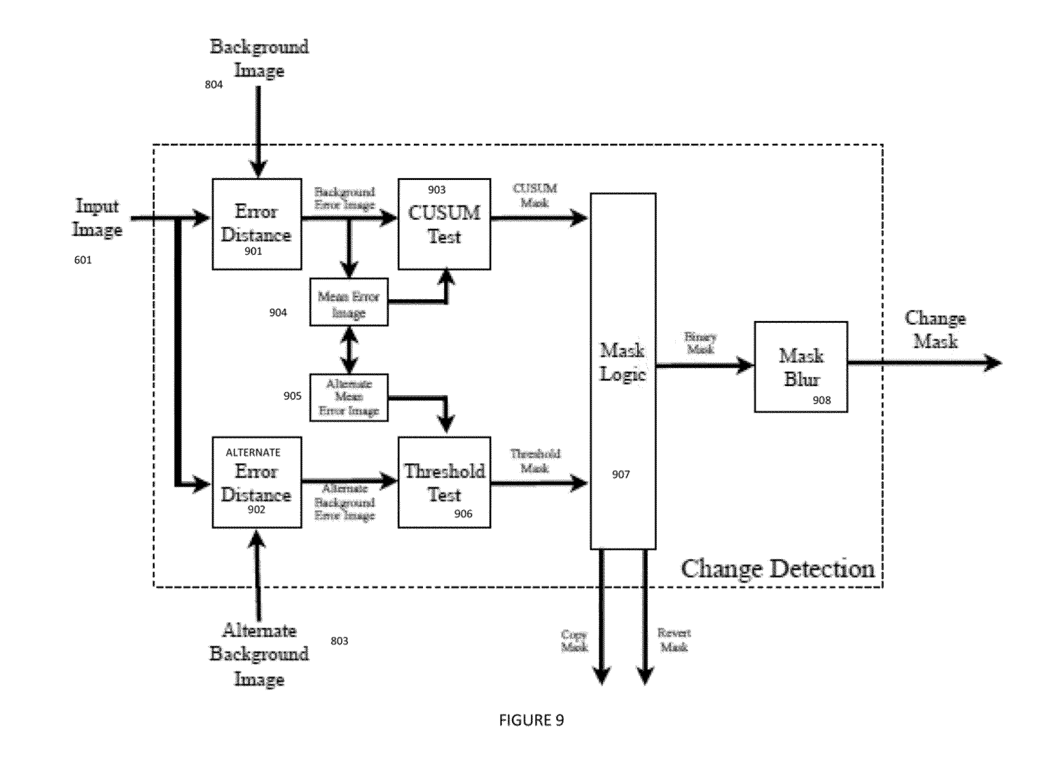

An alternate embodiment of the Change Detection unit is illustrated in FIG. 9. Error Unit 901 receives the Input Image 601 and Background image 803, while Alternate Error Unit 902 receives Input Image 601 along with the Alternate Background Image 804.

The Error Distance unit 901 computes a measure of discrepancy between the input Image I and the Background Image B (or Alternative Background Image A). This yields a numerical value for each pixel or image region. Formally, the Error Distance module computes an Error Image E using a unique function for each pixel p:

Eₚ=fₚ(I,B)

This may consist of any number of image valued functions from current art. For example, the L1 distance between the pixels in the neighborhood centered at p may be used:

$${f}_{p} ( I , B ) = \frac{1}{\vert {𝒩}_{p} \vert} {\sum }_{i ∈ {𝒩}_{p}}^{ } \vert {I}_{i} - {B}_{i} \vert$$

Where Nₚ is the set of pixel indices in a region surrounding pixel p.

The alternate Error Background image IV is given by:

Hₚ=fₚ(I,A)

The Mean Error Image unit 904 computes the Mean Error Image, which is a baseline used for change detection. In one embodiment, this is performed according to the recursive update:

Ēₚ=(1=λ)Ēₚ+λEₚ

where λ is a forgetting factor.

When a region of the Input Image begins a foreground change, the Mean Error values for the pixels in this region are copied to the Alternate Mean Error Image F 905 according to:

$${F}_{p} = \{ \begin{matrix}{\overline{E}}_{p} & if {s}_{{R}_{p}} = 1 \\ {F}_{p} & Otherwise .\end{matrix}$$

This is signaled by the copy Mask s output by the Mask Logic unit 907. The values stored in the Alternate Mean Error Image 905 may be returned to the Mean Error Image 904 according to the revert mask r (output by the Mask Logic unit 907):

$${\overline{E}}_{p} = \{ \begin{matrix}{F}_{p} & if {r}_{{R}_{p}} = 1 \\ {\overline{E}}_{p} & Otherwise .\end{matrix}$$

The CUSUM Test module 903 implements a two-sided CUSUM change detection for every image pixel and can be implemented by known techniques. The role of the CUSUM Test 903 is to test for divergence between the Input Image and the Background Image for every pixel or image region. A pair of CUSUM images are maintained recursively:

dₚ⁺=max(dₚ⁺−Ēₚ−η⁺,0)

dₚ⁻=max(Ēₚ−dₚ⁻−η⁻,0)

where η⁺ and η⁻ are drift parameters. The following threshold rule is then applied to generate the CUSUM mask G:

$${G}_{p} = \{ \begin{matrix}1 & if [ {d}_{p}^{+} > τ ] [ {d}_{p}^{-} > τ ] \\ 0 & Otherwise .\end{matrix}$$

where τ is a threshold parameter. The CUSUM images d⁺p and d⁻p are set to zero for all pixels p, when the pixel reverts to the Alternate Background, that is when rₚ=1.

The Threshold Test unit 906 detects when an Input Image region previously undergoing a foreground change reverts back to the stored region in the Alternate Background Image. The Threshold Mask image J is given by:

$${J}_{p} = \{ \begin{matrix}1 & if [ {H}_{p} < ζ ] \\ 0 & Otherwise .\end{matrix}$$

where ζ is a threshold parameter,

The Mask Logic module 907 takes the CUSUM and Threshold Masks as input and produces the Copy and Revert Masks, as well as Binary Mask K with pixels Kₚ equal to Cₘₐₓ when undergoing foreground change and Cₘᵢₙ otherwise. First, the Copy Mask is determined according to:

sₚ=[Gₚ [symbol] [symbol] K_{p]}

where K is the Binary Mask values from the previous image interation. The Copy Mask takes value 1 when a region begins a foreground change. The Revert Mask is then determined according to:

$${K}_{p} = \{ \begin{matrix}{C}_{min} & if [ {G}_{p} {r}_{p} ] \\ {C}_{max} & Otherwise .\end{matrix}$$

The Binary Mask takes value Cₘᵢₙ when the CUSUM Mask indicates that the Background Image and Input image are perceptually similar or when the region has reverted to the Alternate Background Image. Otherwise, the region is undergoing a foreground change.

Optionally, the resulting Binary Mask may be processed by transforms that take into account the geometric layout of the mask pixels. This may include image morphological operations such as opening, dilation, contraction, or closing. Alternatively, statistical operations such as Binary Random Fields may be used.

The Mask Blur module 908 is a standard image convolution operation (e.g. Box or Gaussian filter) applied to the Binary Mask. This creates smooth transitions between regions undergoing foreground change and background regions, thus preventing visually noticeable edge artifacts.

The system may be implemented in a number of ways. For example, the compression system may be in a camera device. An image sensor (e.g. CMOS, CCD, and the like) generates a video sequence that is then compressed by the system. Then the compressed video is either transmitted over a network or stored locally in the camera.

The compression system may be in an analog video recorder or encoder. Analog video signals (NTSC, PAL, or other legacy format) enter the system, where it is digitized and then compressed with the system. Finally, the compressed video is stored or transmitted over a network.

The system may be implemented as a transcoding device. In such an embodiment, compressed video arrives in digital form via network or storage. It is then decoded and then re-encoded using the system. This further reduces the size of video previously compressed by less efficient means.

Embodiment of Computer Execution Environment (Hardware)

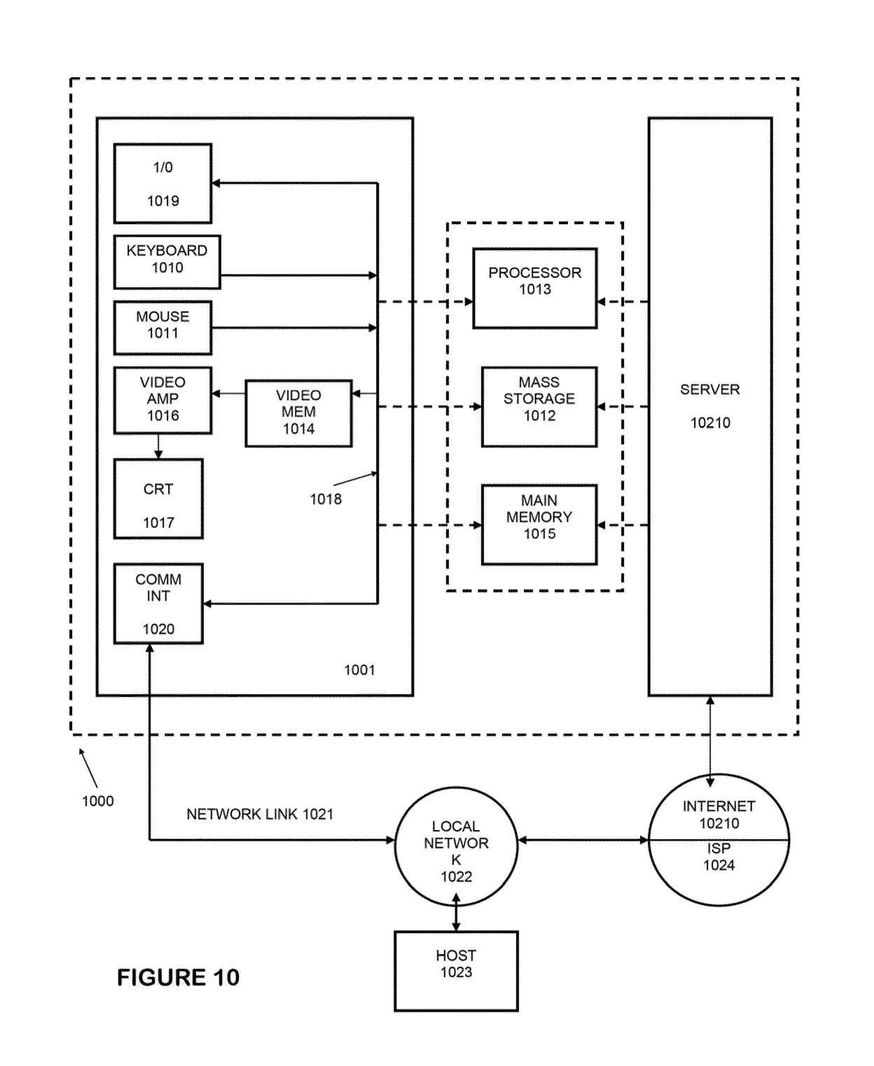

An embodiment of the system can be implemented as computer software in the form of computer readable program code executed in a general purpose computing environment such as environment 1000 illustrated in FIG. 10, or in the form of bytecode class files executable within a Java™ run time environment running in such an environment, or in the form of bytecodes running, on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU 1013. Other suitable input devices may be used in addition to, or in place of, the mouse 1011 and keyboard 1010. I/O (input/output) unit 1019 coupled to hi-directional system bus 1018 represents such I/O elements as a printer, A/V (audio/video) I/O, etc.

Computer 1001 may be a laptop, desktop, tablet, smart-phone, or other processing device and may include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 10210 Local network 1022 and Internet 10210 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 10210 or processor 1013 may have its computational power distributed between computer 1001 and server 10210. Server 10210 symbolically is represented in FIG. 10 as one unit, but server 10210 can also be distributed between multiple “tiers”. In one embodiment, server 10210 comprises a middle and back tier where application logic executes in the middle tier and persistent data is obtained in the back tier. In the case where processor 1013 resides wholly on server 10210, the results of the computations performed by processor 1013 are transmitted to computer 1001 via. Internet 10210, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1011 and processor 1013.

As with processor 1013, in various computing environments, main memory 1015 and mass storage 1012, can reside wholly on server 10210 or computer 1001, or they may be distributed between the two. Examples of systems where processor 1013, main memory 1015, and mass storage 1012 are distributed between computer 1001 and server 10210 include thin-client computing architectures and other personal digital assistants, Internet ready cellular phones and other Internet computing devices, and in platform independent computing environments,

The mass storage 1012 may include both fixed and removable media, such as magnetic, optical or magnetic optical storage systems or any other available mass storage technology. The mass storage may be implemented as a RAID array or any other suitable storage means. Bus 1018 may contain, for example, thirty-two address lines for addressing, video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines may be used instead of separate data and address lines.

In one embodiment of the invention, the processor 1013 is a microprocessor such as manufactured by Intel, AMD, Sun, etc. However, any other suitable microprocessor or microcomputer may be utilized, including a cloud computing solution. Main memory 1015 is comprised of dynamic random access memory (DRAM). Video memory 1014 is a dual-ported video random access memory. One port of the video memory 1014 is coupled to video amplifier 1019. The video amplifier 1019 is used to drive the cathode ray tube (CRT) raster monitor 1017. Video amplifier 1019 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 10210 might transmit a requested code for an application program through Internet 10210, ISP 1024, local network 1022 and communication interface 1020. The received code may be executed by processor 1013 as it is received, and/or stored in mass storage 1012, or other non-volatile storage for later execution. The storage may be local or cloud storage. In this manner, computer 1000 may obtain application code in the form of a carrier wave. Alternatively, remote server computer 10210 may execute applications using processor 1013, and utilize mass storage 1012, and/or video memory 1015. The results of the execution at server 10210 are then transmitted through Internet 10210, ISP 1024, local, network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment, or may be implemented with special purpose hardware, such as application specific integrated circuits (ASICs) and the like

While the system has been described with respect to a limited number of embodiments, it will be appreciated that many variations, modifications, and other applications of the system may be made.

What is claimed is:

1. A method for compressing an image comprising:
Receiving an image region from an input image;
Determining if the image region is classified as a Background Region;
For an image region characterized as a Background Region;
Calculating a reconstruction error for the image region;
Comparing the error to a threshold;
Continuing to classify the image region as a Background Region when the error is below the threshold;
Changing the classification of the image region when the error is above the threshold.

2. The method of claim 1 further including:
For an image region not classified as a Background Block;
Calculating a reconstruction error for the image region;
Comparing the error to a threshold;
Maintaining the classification as not a Background Region when the error is above the threshold;
Changing the classification of the image region when the error is below the threshold.

3. The method of claim 2 wherein an image region that is not a Background Region is an Anomaly Region.

4. The method of claim 1 further including the use of a Scene Model to class if Background Regions.

5. The method of claim 4 wherein the Scene Model represents a variability associated with the background of an image.

6. The method of claim 5 wherein the image represents a frame of video.

7. The method of claim 6 wherein the image is of a stationary scene.

8. The method of claim 1 wherein Background Regions are ignored in a compression process.

9. The method of claim 1 wherein the image region is a pixel.

10. The method of claim 1 wherein the image region is a macroblock.

11. A method of compressing an image comprising:
Receiving an image region from an input image;
Comparing the image region to a reference image to identify a difference value;
Setting a change mask to a first value when the difference value is below a threshold value;
Setting the change mask to a second value when the difference value is above a threshold value.

12. The method of claim 11 further including:
For an image region having a change mask of the second value;
Comparing the image region to a prior corresponding macroblock to generate a second difference value;
Updating a count when the second difference value is above a threshold value;
Updating a replace mask value when the count is above a threshold count value.

13. The method of claim 12 wherein the first change mask value represents a Background Region.

14. The method of claim 13 wherein the second change mask value represents an Anomaly Region.

15. The method of claim 14 wherein the updated replace mask value represents an image region that is now a Background Region.

16. The method of claim 15 wherein the system uses a Perceptual Filter to classify the image region.

17. The method of claim 11 wherein the image region is a pixel.

18. The method of claim 11 wherein the image region is a macroblock.
